(19) United States
(12) Patent Application Publication
(10) Pub. No.: US 2026/0211413 A1
(43) Pub. Date: Jul. 23, 2026

(54) PROCESSING SYSTEM, PROCESSING METHOD, AND RECORDING MEDIUM

(71) Applicant: Mitsubishi Electric Corporation, Tokyo (JP)

(72) Inventors: Yasuhiro TOYAMA, Tokyo (JP); Koji NAGAMATSU, Tokyo (JP); Hidematsu HAYASHI, Tokyo (JP)

(73) Assignee: Mitsubishi Electric Corporation, Tokyo (JP)

(21) Appl. No.: 19/142,978

(22) PCT Filed: Jan. 18, 2023
(86) PCT No.: PCT/JP2023/001372

§ 371 Date: Jun. 25, 2025

(51) Int. Cl. G05B 23/02

(52) U.S. Cl. CPC G05B 23/0289; G05B 2223/04

(57) ABSTRACT

A processing system includes a processing device to process an object based on setting data, a model information acquirer to acquire model information indicating a first model to be applied to the setting data to suppress an error included in a processing result of the processing device due to a unique characteristic that is unique to the processing device before being installed in the factory, and a learner to learn a second model for suppressing an error between a target value and a processing result of the processing device that processes an object in the factory using the first model based on the setting data input in the factory. The processing device processes an object based on the results of applying the first model and the second model to the setting data.

### TECHNICAL FIELD

The present disclosure relates to a processing system, a processing method, and a program.

### BACKGROUND ART

In the field of factory automation (FA), systems that realize processing steps like manufacturing lines are built up using various devices. As devices constituting such a system, a required number of devices of a model with capabilities suitable for processing steps to be realized are usually adopted. However, even if the devices are of the same model, those devices might not always exhibit exactly the same capabilities when installed on-site, and there may be variations in the capabilities of the devices.

Thus, estimating capability differences of the devices and executing processing on the devices considering the capability differences are considered with a technique of learning a model to estimate output when conditions are changed (for example, see Patent Literature 1). When using this technique, factors that may affect the capabilities of the devices can be specified as conditions. Also, if the capability differences can be estimated with the model, a model to obtain output that suppresses the capability differences can be obtained.

### CITATION LIST

### Patent Literature

Patent Literature 1: Unexamined Japanese Patent Application Publication No. 2021-170163

### Summary of Invention

However, there are many factors that can affect the capabilities exhibited by the devices on-site, and there may be a significant computational load involved in learning the model.

The present disclosure is made in view of the above circumstances, and an objective of the present disclosure is to reduce the computational load for learning a model to suppress the capability differences of the devices.

### Solution to Problem

To achieve the above objective, a processing system of the present disclosure includes input means for receiving input of setting data; a processing device to be installed in a factory and process an object based on the setting data; model information acquiring means for acquiring model information indicating a first model to be applied to the setting data to suppress a first error included in a first processing result of the processing device due to a unique characteristic that is unique to the processing device before being installed in the factory; environment information acquiring means for acquiring factory environment information indicating environment of the processing device installed in the factory; error information acquiring means for acquiring first error information indicating a second error between a target value and a second processing result of the processing device that processes the object in the factory using the first model based on the setting data input in the factory; and learning means for learning a second model to suppress the second error from the factory environment information and the first error information, wherein the processing device processes the object based on results of applying the first model and the second model to the setting data.

### Advantageous Effects of Invention

According to the present disclosure, the model information acquiring means acquires the model information indicating the first model to be applied to the setting data to suppress the first error included in the first processing result of the processing device due to a unique characteristic that is unique to the processing device before being installed in the factory, and the learning means learns the second model for suppressing a second error between the target value and the second processing result of the processing device that processes the object in the factory. This allows for the second model to be learned that suppresses the capability differences caused by the environment of the processing devices installed in the factory, separately from the first model that suppresses the capability differences occurring before the device is installed in the factory. Thus, the factors that may affect the capabilities of the devices are separated and the second model is learned to address the capability differences due to some of the factors. This can reduce computational load for learning the model that suppresses the capability difference of the devices.

### BRIEF DESCRIPTION OF DRAWINGS

FIG. 1 is a schematic diagram illustrating a processing system according to Embodiment 1;

FIG. 2 is a diagram illustrating a hardware configuration of the processing device according to Embodiment 1;

FIG. 3 is a diagram illustrating a functional configuration of the processing device according to Embodiment 1;

FIG. 4 is a diagram illustrating an example of model information of a first model according to Embodiment 1;

FIG. 5 is a diagram illustrating an example of a second model according to Embodiment 1;

FIG. 6 is a flowchart illustrating a model application process according to Embodiment 1;

FIG. 7 is a diagram illustrating a functional configuration of a processing device according to a modified example;

FIG. 8 is a schematic diagram illustrating a processing device according to Embodiment 2;

FIG. 9 is a diagram illustrating a functional configuration of the processing device according to embodiment 2;

FIG. 10 is a flowchart illustrating a first model generation process according to Embodiment 2;

FIG. 11 is a flowchart illustrating a model application process according to Embodiment 2;

FIG. 12 is a diagram illustrating a functional configuration of a processing device 10 according to Embodiment 3;

FIG. 13 is a diagram illustrating a configuration of a recipe bank according to Embodiment 3;

FIG. 14 is a diagram illustrating a functional configuration of a processing device according to Embodiment 4;

FIG. 15 is a diagram for explaining an estimation model according to Embodiment 4:

FIG. 16 is a diagram illustrating an example of the estimation model according to Embodiment 4;

FIG. 17 is a flowchart illustrating an estimation model application process according to Embodiment 4;

FIG. 18 is a flowchart illustrating an estimation model generation process according to Embodiment 4;

FIG. 19 is a flowchart illustrating a model improvement process according to Embodiment 5;

FIG. 20 is a diagram for explaining a search for a combination of the second model and the estimation model according to Embodiment 5;

FIG. 21 is a diagram illustrating a configuration of a processing system according to a modified example;

FIG. 22 is a diagram illustrating a configuration of a processing device according to a modified example; and

FIG. 23 is a diagram illustrating a first model according to a modified example.

### DESCRIPTION OF EMBODIMENTS

A processing system according to embodiments of the present disclosure is described in detail with reference to the drawings.

### Embodiment 1

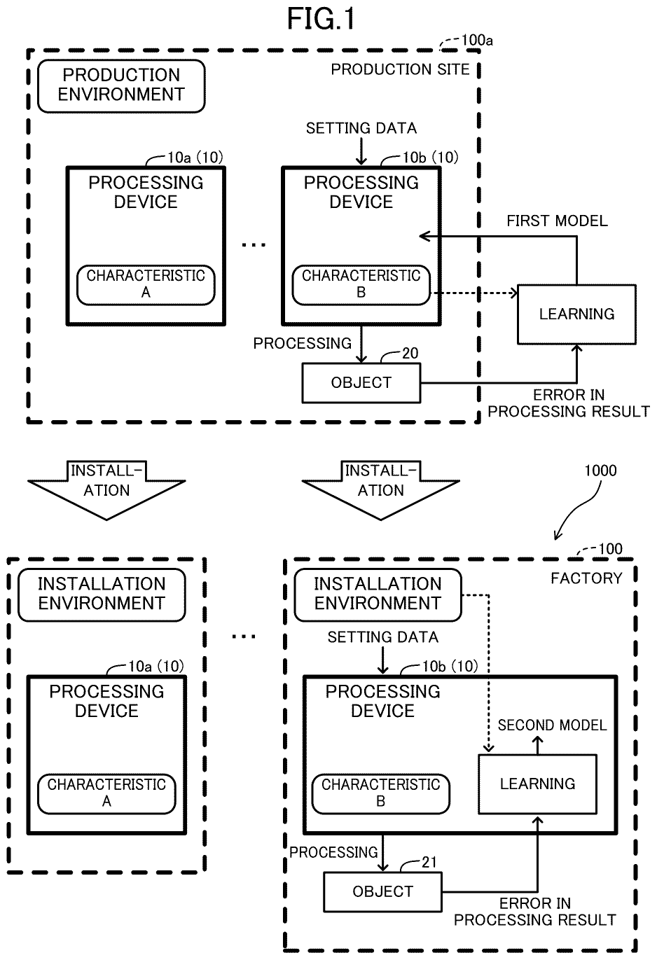

As illustrated in FIG. 1, a processing system 1000 according to the present embodiment is built up by installing a processing device 10b in a factory 100, among the processing devices 10a and 10b of the same model produced in a production site 100a.

The processing system 1000 includes the processing device 10b. Hereinafter, the processing devices 10a and 10b may be referred to as the processing device 10 without distinguishing one from another.

The processing device 10 is an FA device or equipment that processes objects 20 and 21, such as machine tools. The object 20 is a processing target at the production site 100a, and the object 21 is a processing target at the factory 100. The processing performed by the processing device 10 includes, for example, cutting or grinding the objects 20 and 21 that are workpieces, assembling the objects 20 and 21 that are products, or assembling the objects 20 and 21 that are parts of products with other components. The processing device 10 processes the objects 20 and 21 based on the setting data input by a user. The setting data are parameters set in the processing device 10 for the processing device 10 to process the objects 21 and 22 and include, for example, positions and speeds of tools and stages supporting the workpieces and rotational speeds of the tools.

However, the processing device 10 has variances among devices at the stage of being produced at the production site 100a. That is, the processing devices 10a and 10b have characteristics unique to their respective devices, and due to these characteristics, errors from the target value may occur in the results of processing the object 20 at the production site 100a. FIG. 1 illustrates that the processing device 10a has characteristic A, and the processing device 10b has characteristic B. The processing result is, for example, a cutting result of the object 20, and the error in the processing result is a dimensional error of the cut object 20. The target value may be a specification value directly indicated by the setting data or a value intended by the user as a value associated with the setting data. The target value may or may not be included in the setting data. Even if the target value is not included in the setting data, the target value is usually associated with the setting data and may be separately input into the processing device 10 by the user.

Since errors in the processing results may occur due to the unique characteristics of the processing device 10, the first model is learned at the production site 100a to suppress these errors, and the learned first model is incorporated into the processing device 10, thereby equalizing the capabilities of the processing devices 10 shipped from the production site 100a.

Then, when the processing device 10 is installed in the factory 100, errors may occur in the processing results of the object 21 due to the installation environment of the processing device 10 at the factory 100. The installation environment includes, for example, temperature, humidity, or the type of material inserted into the processing device 10. In the circumstances, the processing device 10 learns the second model to suppress errors caused by the installation environment and processes the object 21 using the learned second model, thus performing processing adapted to the installation environment. The processing devices 10a and 10b each learn and use the second model, thereby reducing variations in the processing results of the object 21 under different environments and exhibiting uniform capabilities. FIG. 1 illustrates the learning related to the processing device 10b as a representative example, but the learning related to the processing device 10a is performed similarly to the processing device 10b.

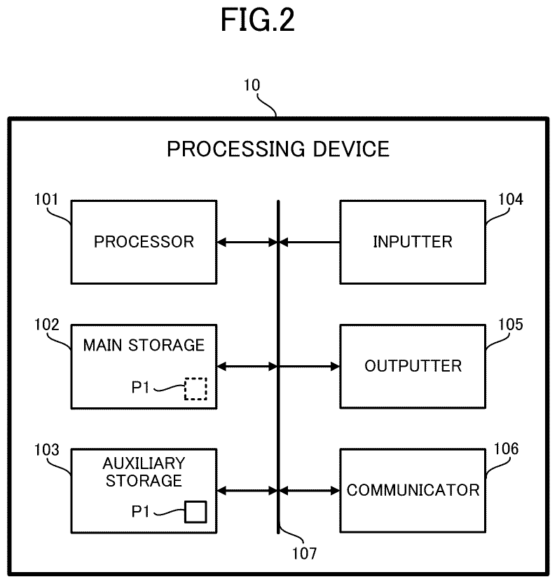

The processing device 10 includes hardware elements to function as a computer. Specifically, as illustrated in FIG. 2, the processing device 10 includes a processor 101, a main storage 102, an auxiliary storage 103, an inputter 104, an outputter 105, and a communicator 106. The main storage 102, the auxiliary storage 103, the inputter 104, the outputter 105, and the communicator 106 are all connected to the processor 101 via an internal bus 107.

The processor 101 includes a central processing unit (CPU) as a processing circuit. The processor 101 executes a program P1 stored in the auxiliary storage 103 to implement various functions to perform the processes described below.

The main storage 102 includes a random access memory (RAM). The program P1 is loaded from the auxiliary storage 103 into the main storage 102. The main storage 102 is used as a work area of the processor 101.

The auxiliary storage 103 includes a nonvolatile memory such as an electrically erasable programmable read-only memory (EEPROM) or a hard disk drive (HDD). In addition to the program P1, the auxiliary storage 103 stores various types of data used in processing performed by the processor 101. The auxiliary storage 103 provides data to be used by the processor 101 to the processor 101 as instructed by the processor 101. Also, the auxiliary storage 103 stores the data provided by the processor 101.

The inputter 104 includes input devices, such as a hardware switch, an input key, a keyboard, and a pointing device. The inputter 104 acquires information input by the user of the processing device 10 and provides the acquired information to the processor 101.

The outputter 105 includes an output device such as a light emitting diode (LED), a liquid crystal display (LCD), and a speaker. The outputter 105 provides various types of information to the user in accordance with the instructions from the processor 101.

The communicator 106 includes a communication interface circuit for communicating with external devices. The communicator 106 receives signals from the outside and outputs data indicated by the received signals to the processor 101. The communicator 106 also transmits, to external devices, signals indicating data output by the processor 101.

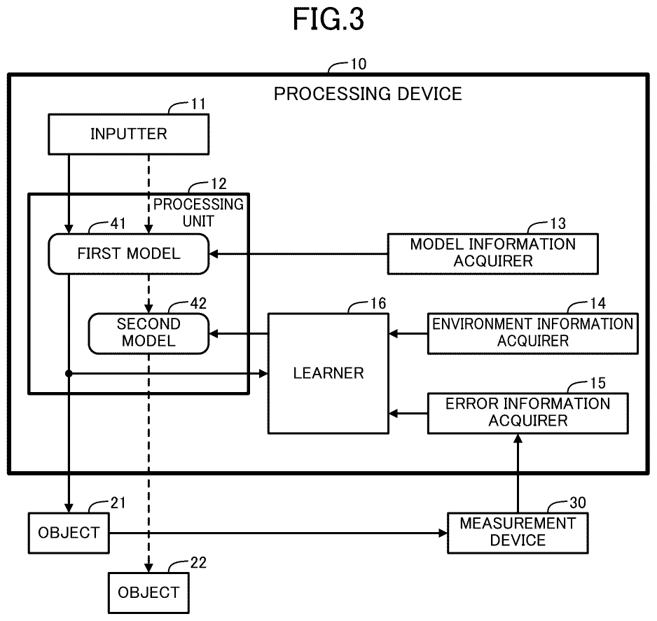

With cooperation of the above hardware configuration, the processing device 10 performs various functions in the factory 100. Specifically, as illustrated in FIG. 3, the processing device 10 functionally includes an inputter 11 that receives setting data, a processing unit 12 that executes processing based on the setting data, a model information acquirer 13 that acquires model information indicating a first model 41 learned at the production site 100a, an environment information acquirer 14 that acquires environment information indicating the installation environment, an error information acquirer 15 that acquires error information indicating an error when the object 21 is processed using the first model 41, and a learner 16 that learns, from the environment information and error information, a second model 42 to suppress the error. In FIG. 3, the solid arrows indicate the flow of information before learning the second model, and the dashed arrows indicate the flow of information after learning the second model.

The inputter 11 is mainly implemented by the inputter 104 or the communicator 106. The inputter 11 receives setting data input by the user. Among the objects 21 and 22 processed based on the setting data, the object 21 is a processing target before learning the second model 42, and the object 22 is a processing target after learning the second model 42. The inputter 11 corresponds to an example of input means for receiving setting data.

The processing unit 12 is mainly implemented by the processor 101 and a processing module for processing the objects 21 and 22. The processing module includes, for example, a motor for moving tools and stages. The processing unit 12, before learning of the second model 42, applies the first model 41 to the setting data input into the inputter 11 and processes the object 21. When the second model 42 is learned by the learner 16 by processing the object 21, the processing unit 12 sequentially applies the first model 41 and the second model 42 to the setting data and processes the object 22. For learning of the second model 42, the processing unit 12 provides the output of the first model 41 to the learner 16.

The model information acquirer 13 is implemented by at least one of the processor 101, the inputter 104, and the communicator 106. The model information acquirer 13 may read out model information registered in the auxiliary storage 103 of the processing device 10 transferred from the production site 100a, or may read out model information from a recording medium such as a memory card attached to the processing device 10 when the processing device 10 is transferred. Further, the model information acquirer 13 may acquire model information directly input by a user or receive model information via a communication line or network.

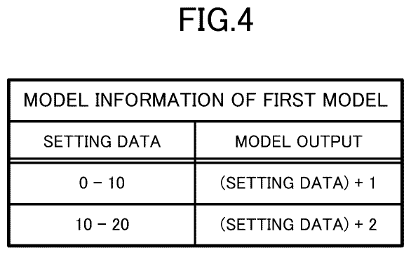

FIG. 4 illustrates a simple example of the model information of the first model 41. The model information in FIG. 4 illustrates that when the value of the setting data is zero or more and less than 10, the model output obtained by applying the first model 41 to the setting data is the sum obtained by adding one to the value of the setting data, and when the value of the setting data is 10 or more and less than 20, the model output is the sum obtained by adding two to the value of the setting data. The first model 41 is not limited to the conversion table illustrated in FIG. 4 and may be a model expressed as a function by a mathematical formula. The model information acquirer 13 corresponds to an example of model information acquiring means that acquires model information indicating the first model to be applied to the setting data to suppress the first error included in the first processing result of the processing device due to characteristics unique to the processing device before being installed in the factory. Here, the first processing result and the first error are distinguished the processing result and the error in the production site from the second processing result and the second error in the factory 100 described later.

Returning to FIG. 3, the environment information acquirer 14 is implemented by at least one of the processor 101, the inputter 104, or the communicator 106. The environment information acquirer 14 acquires environment information indicating the installation environment of the processing device 10 that is an environment when the processing unit 12 processes the object 21 using the first model 41 without using the second model 42. The environment information acquirer 14 may read out the environment information from the main storage 102, the auxiliary storage 103, or a recording medium, may acquire the environment information directly input by a user, or may receive the environment information from a sensor that measures environmental conditions via a communication line or network. The environment indicated by the environment information may include temperature, humidity, and the type of material as described above, the power environment provided to the processing device 10 in the factory 100, the quality of air or gas, or the output of other devices connected to the processing device 10. The environment information acquirer 14 corresponds to an example of environment information acquiring means for acquiring factory environment information indicating the environment of the processing device installed in the factory.

The error information acquirer 15 is implemented by at least one of the processor 101, the inputter 104, or the communicator 106. From a measurement device 30 that measures a processing result of the object 21 processed by the processing unit 12, the error information acquirer 15 acquires, as an error, a difference between the target value and the measured value as the processing result. The error information acquirer 15 may acquire the error information by separately acquiring the processing result and the target value. That is, the error information may be information indicating both the actual measured value and the target value of the processing result. The error information acquirer 15 may acquire the error information through communication with the measurement device 30, may read out the error information from the recording medium, or may acquire the error information directly input by a user. The error information acquirer 15 corresponds to an example of error information acquiring means that acquires first error information indicating a second error with a target value and a second processing result of the processing device that processes the object in the factory using the first model based on the setting data input in the factory.

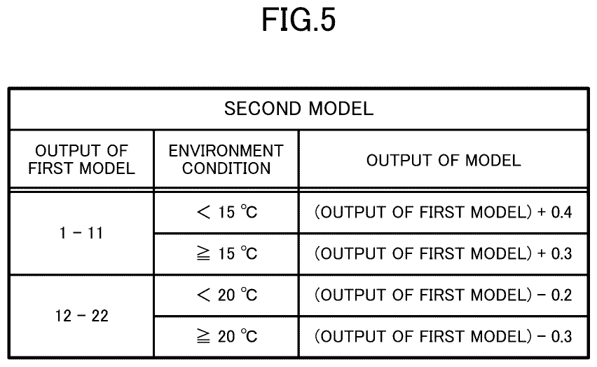

The learner 16 is mainly implemented by the processor 101. The learner 16 learns the second model 42 to suppress the error based on the output of the first model 41, the error as a result of processing the object 21 using this output, and the installation environment at a time of processing the object 21 using this output. FIG. 5 illustrates a simple example of the second model 42 to be learned. The second model 42 in FIG. 5 indicates that in a case where the output of the first model 41 is 1 or more and less than 11, when the temperature as the installation environment is less than 15° C., the output of the second model 42 is a sum obtained by adding 0.4 to the output of the first model 41, and when the temperature is 15° C. or more, the output of the second model 42 is a sum obtained by adding 0.3 to the output of the first model 41. Further, in a case where the output of the first model 41 is 12 or more and less than 22, when the temperature is less than 20° C., the output of the second model 42 is the difference obtained by subtracting 0.2 from the output of the first model 41, and when the temperature is 20° C. or more, the output of the second model 42 is the difference obtained by subtracting 0.3 from the output of the second model 42. The second model 42 is not limited to the conversion table illustrated in FIG. 5 and may be a model expressed as a function by a mathematical formula. Returning to FIG. 3, upon learning the second model 42, the learner 16 provides the second model 42 to the processing unit 12. The learner 16 corresponds to an example of learning means for learning the second model to suppress the second error from the environment information and error information. The second model 42 corresponds to an example of a model for obtaining, from the output value and the environment information, a corrected value of the output value of the first model 41.

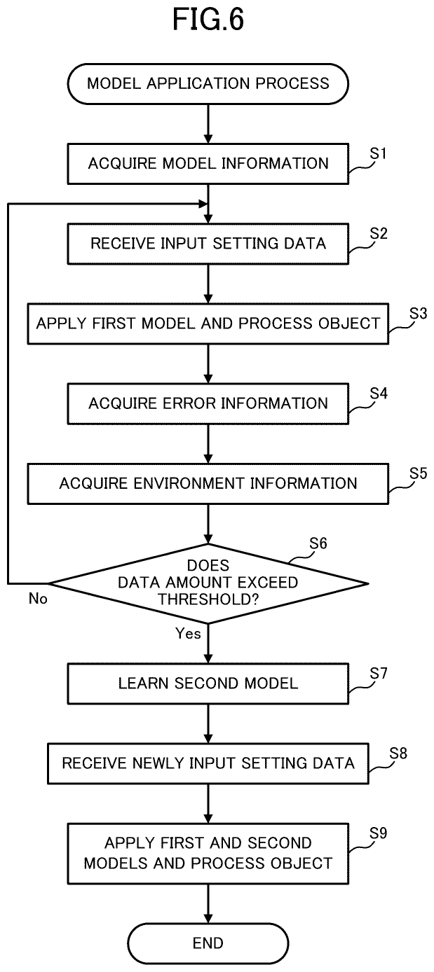

Next, the model application process executed by the processing device 10 is described with reference to FIG. 6. The model application process illustrated in FIG. 6 is executed as adjustment operation or initialization processing before start of normal operation after the processing device 10 is installed in the factory 100.

In the model application process, the model information acquirer 13 acquires model information (step S1). Then, the inputter 11 receives the input setting data (step S2), the processing unit 12 applies the first model 41 to the setting data and processes the object 21 (step S3), the error information acquirer 15 acquires the error information (step S4), and the environment information acquirer 14 acquires the environment information (step S5).

Next, the learner 16 determines whether the accumulated amount of data of records including the output of the first model 41, the error information, and the environment information associated with each other by executing steps S2 to S5 exceeds the threshold (step S6). If determination is made that the amount of data does not exceed the threshold (No in step S6), the processing device 10 repeats the processing from step S2 onward. This accumulates data that is a combination of the output of the first model 41, the error information, and the environment information.

When determination is made that the amount of data exceeds the threshold (Yes in step S6), the learner 16 learns the second model 42 using the accumulated data (step S7). For example, the learner 16 generates a temporary model representing a relationship between the output of the first model 41, the error, and the installation environment by regression analysis, and then obtains, as the second model 42, a conversion formula for the output of the first model 41 such that the error is small.

However, the learning of the second model 42 by the learner 16 is not limited thereto, and supervised learning represented by neural networks or reinforcement learning may be used.

Next, the inputter 11 receives newly input setting data (step S8), and the processing unit 12 applies the first model 41 and the second model 42 to the new setting data and processes the object 22 (step S9). This allows processing with a small error by applying the second model.

As described above, the model information acquirer 13 acquires the model information indicating the first model 41, to be applied to the setting data to suppress the error included in the processing result of the processing device 10 due to characteristics unique to the processing device 10 before being installed in the factory 100.

Furthermore, the learner 16 learns the second model 42 for suppressing the error in the processing result of the processing device 10 that processes the object 21 in the factory 100. Thus, the second model 42 is learned that suppresses the capability difference caused by the environment in which the processing device 10 is installed in the factory 100, separately from the first model 41 that suppresses the capability difference occurring before the processing device 10 is installed in the factory 100. Thus, the factors that may affect the capability of the device are separated and the second model 42 is learned in the factory 100 to address the capability difference caused by some of the factors.

This can reduce computational load for learning the model that suppresses the capability difference of the devices.

That is, the information used by the learner 16 to learn the second model 42 excludes the information indicating the characteristics unique to the processing device 10. This can avoid the occurrence of unnecessary computational processing due to similar learning conducted both at the production site 100a and the factory 100.

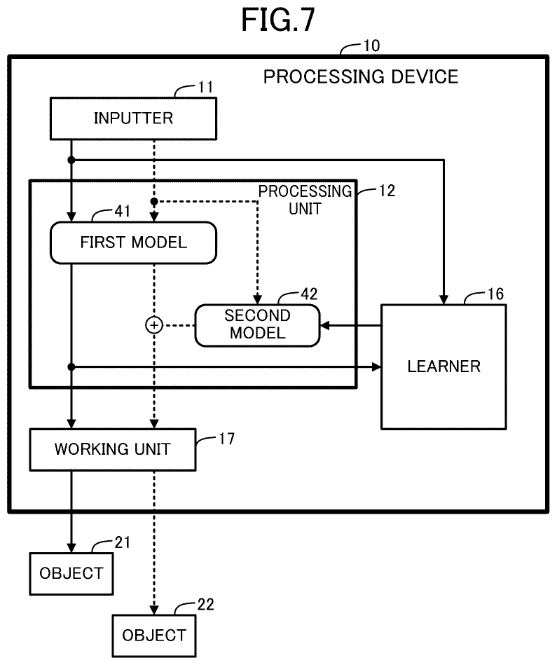

The second model 42 for obtaining the output of the processing device 10 from the output of the first model 41 is described above, but not limited thereto. As illustrated in FIG. 7, the first model 41 and the second model 42 can be applied in parallel to the setting data, and after the second model 42 is learned, the sum of the outputs of the first model 41 and the second model 42 can be input to a working unit 17 that processes the objects 21 and 22. The second model 42 can be applied in any form that can correct the processing of the object 21 based on the first model 41. In the example of FIG. 7, the learner 16 may collect the setting data to learn the second model 42.

### Embodiment 2

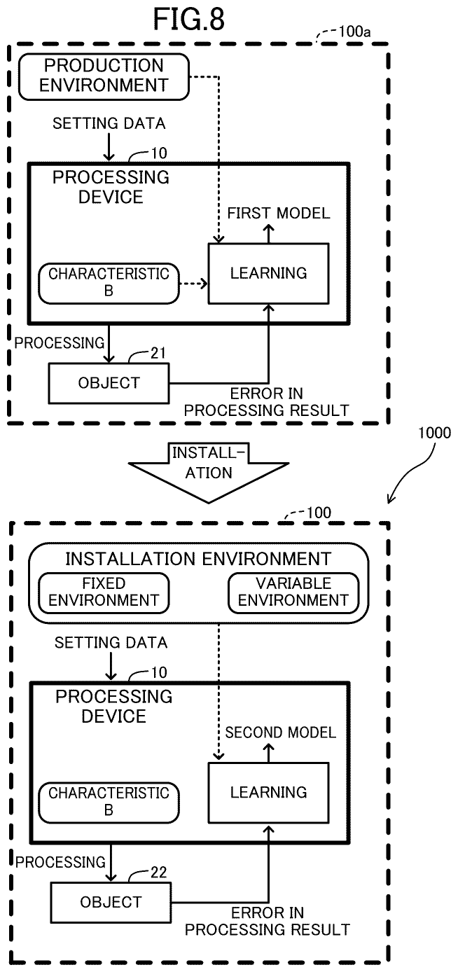

Next, Embodiment 2 is described, focusing on differences from Embodiment 1 described above. The same reference signs denote the components that are the same as or similar to those in Embodiment 1. The present embodiment differs from Embodiment 1 in that the processing device 10 has the capability of learning the first model as illustrated in FIG. 8. Additionally, the present embodiment differs from Embodiment 1 in that the learner 16 learns the second model by separating the installation environment into a fixed environment, which is fixed in the factory 100, and a variable environment, which can vary over time.

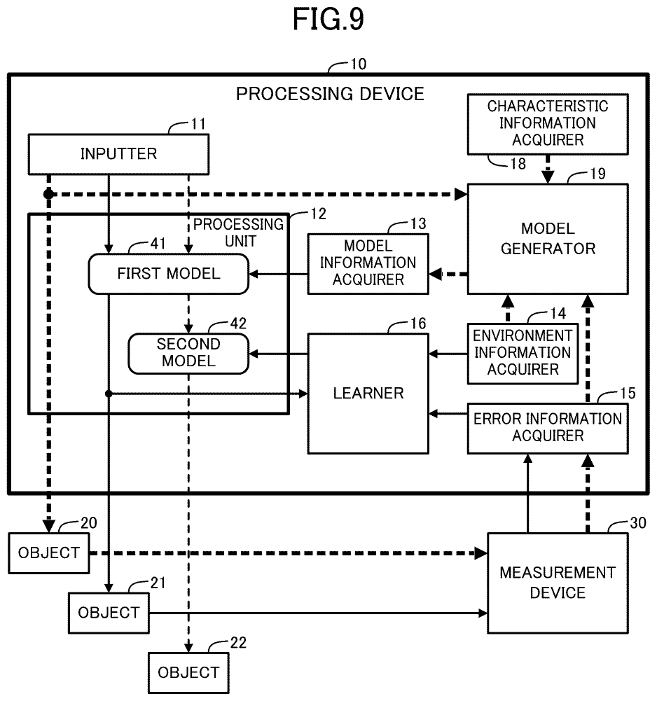

The processing device 10 according to the present embodiment includes the characteristic information acquirer 18 that indicates the characteristics unique to the processing device 10, and a model generator 19 that generates the first model 41, as illustrated in FIG. 9. In FIG. 9, a flow of information at the production site 100a is indicated by thick arrows.

The characteristic information acquirer 18 is implemented by at least one of the processor 101, the inputter 104, or the communicator 106. The characteristic information acquirer 18 acquires the characteristic information indicating the characteristics unique to the processing device 10 at the production site 100a. The characteristic information acquirer 18 may read out the characteristic information from the auxiliary storage 103 or an external recording medium, acquire the characteristic information directly input by the user, or receive the characteristic information via a communication line or network. The characteristic information indicates, for example, the results of quality inspections conducted on a plurality of processing devices 10 at the production site 100a. The characteristic information acquirer 18 corresponds to an example of characteristic information acquiring means for acquiring the characteristic information indicating the characteristics unique to the processing device 10.

The model generator 19 is mainly implemented by the processor 101. The model generator 19 acquires the setting data input into the inputter 11 and acquires, from the error information acquirer 15 that acquired this error information, the error information indicating the error of the object 20 processed by the processing unit 12 without using the first model 41 based on the setting data. This error information corresponds to an example of the second error information indicating the first error described above. The model generator 19 also acquires the environment information indicating a production environment in the production site where the processing device 10 is produced, from the environment information acquirer 14 having acquired the environment information, and acquires the characteristic information indicating the characteristics of the processing device 10 itself from the characteristic information acquirer 18. Then, the model generator 19 generates the first model 41 by learning from the acquired information and provides the first model 41 to the model information acquirer 13. For example, the model generator 19 generates the first model 41 for obtaining the setting data that minimizes the error by regression analysis or supervised learning, using the setting data as a response variable and the error information, environment information, and characteristic information as explanatory variables.

Additionally, in cases where the correction values of the setting data in accordance with the environmental conditions are statistically predetermined and variations due to the characteristics of the processing device occur, the model generator 19 may learn the first model 41 to reduce such variations using the characteristic information. Moreover, the model generator 19 may generate the first model 41 by regression analysis or supervised learning, using the error information as the response variable and the setting data, environment information, and characteristic information as the explanatory variables.

The model generator 19 corresponds to an example of model generation means for generating the first model from the characteristic information, the environment information of the production environment, and the second error information.

The method of generating the first model 41 by the model generator 19 may be arbitrarily changed. For example, one or both of the characteristic information and the environment information may be omitted from information for use to generate the first model 41. Even in a case where one or both of the characteristic information and the environment information are omitted, the first model 41 generated by the model generator 19 is consequently a model for suppressing the error caused by the characteristics of the processing device 10. The model generator 19 may also generate the first model 41 by applying the characteristic information and the environment information to a template model provided externally at the production site 100a.

Next, the first model generation process executed by the processing device 10 at the production site 100a and the model application process executed in the factory 100 are sequentially described.

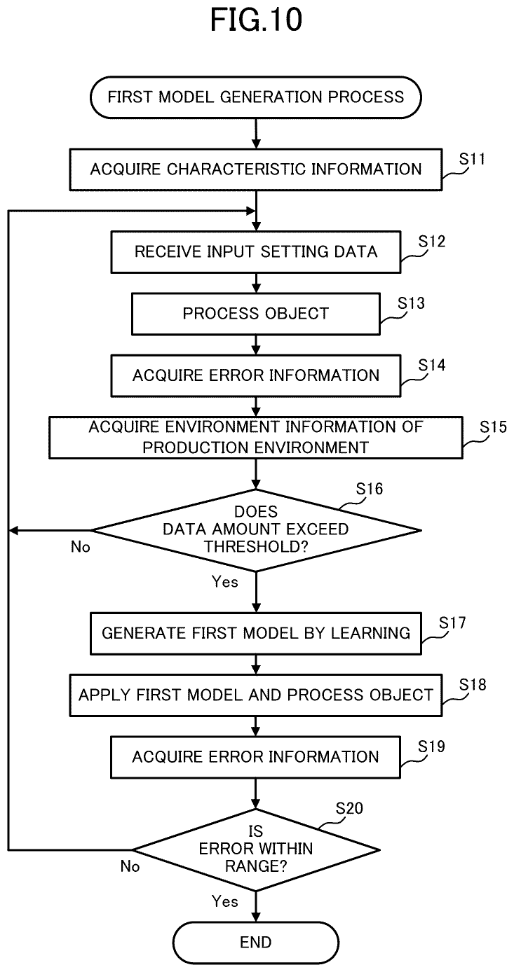

In the first model generation process, as illustrated in FIG. 10, the characteristic information acquirer 18 acquires the characteristic information (step S11). Then, the inputter 11 receives the input setting data (step S12), the processing unit 12 processes the object 20 based on the setting data (step S13), the error information acquirer 15 acquires the error information (step S14), and the environment information acquirer 14 acquires the environment information of the production environment (step S15). The environment information of the production environment may be the same type of information as the installation environment or different information. The environment information of the production environment can be any information that indicates environmental factors that affect the quality of the processing device 10. The environment information of the production environment corresponds to an example of production environment information.

Next, the model generator 19 determines whether the amount of data obtained in steps S12 to S15 exceeds a predetermined threshold (step S16). When determination is made that the amount of data does not exceed the threshold (No in step S16), the processing device 10 repeats the processing from step S12 onward. This accumulates the data necessary for generating the first model 41.

When determination is made that the amount of data exceeds the threshold (Yes in step S16), the model generator 19 generates the first model 41 by learning based on the information obtained in steps S11 to S15 (step S17). Next, the processing unit 12 applies the generated first model 41 to the setting data acquired in step S12 and processes the object 21 (step S18), and the error information acquirer 15 acquires the error information (step S19). Then, the model generator 19 determines whether the error acquired when the first model 41 is applied to the setting data and the object 21 is processed is within a predetermined range (step S20).

When determination is made that the error is not within this range (No in step S20), the process returns to step S12, and addition of data through re-execution of steps S12 to S16 and generation of the first model in steps S17 to S19 are repeated. This allows the model generator 19 to continue the learning of the first model 41. During the repeated learning, the first model 41 may be learned based on newly collected data without using previously collected data. Additionally, in a case where the predetermined processing iterations in the learning of the first model 41 in step S17, such as the update of weights in each layer in deep learning, are cut short, when the determination in step S20 is negative (No in step S20), learning iterations may continue by returning to step S17 without additional data collection. When determination is made that the error is within the range in step S20 (Yes in step S20), the processing device 10 ends the first model generation process.

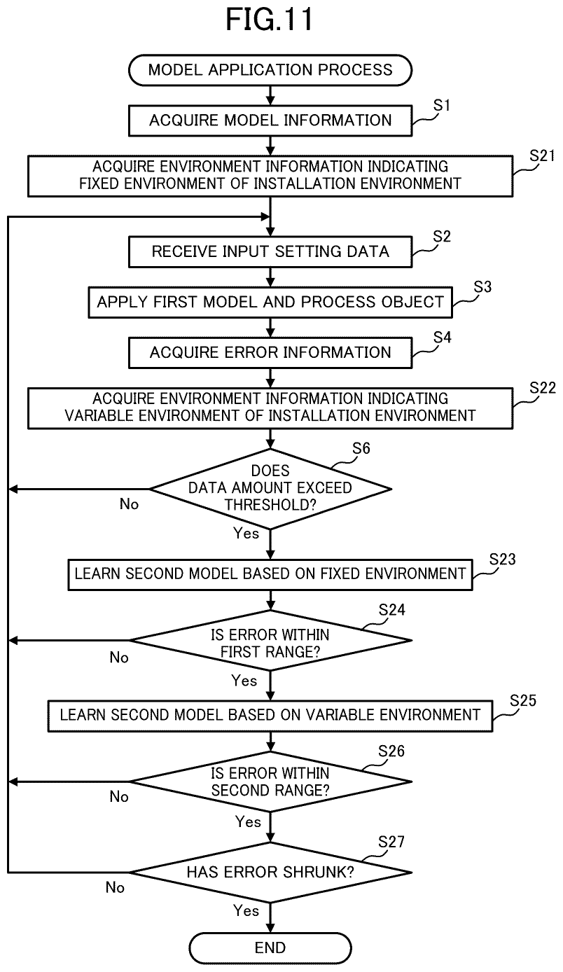

As illustrated in FIG. 11, in the model application process according to the present embodiment, step S1 is executed as in Embodiment 1, and then the environment information acquirer 14 acquires the environment information indicating the fixed environment of the installation environment (step S21). The fixed environment is an environment fixed by installation of the processing device 10 or adjustment during installation of the processing device 10. Specifically, the fixed environment is the presence or absence of A/D conversion execution for externally applied voltage, or the type of mounting member selected for the space.

Next, after executing steps S2 to S4 as in Embodiment 1, the processing device 10 acquires the environment information indicating the variable environment of the installation environment (step S22). The variable environment is an environment that can vary each time the objects 21 and 22 are processed, such as temperature or humidity. Then, the learner 16 determines whether the amount of data exceeds the threshold (step S6), and when determination is made that the amount of data does not exceed the threshold (No in step S6), the processing from step S2 onward is repeated.

When determination is made that the amount of data exceeds the threshold (Yes in step S6), the learner 16 learns the second model 42 based on the fixed environment indicated by the environment information acquired in step S11 (step S23). Here, the learner 16 learns the second model 42 without considering the variable environment indicated by the environment information acquired in step S22. In other words, the learner 16 learns the second model 42 without including the variable environment as a parameter, or learns the second model 42 with the parameters of the variable environment fixed regardless of the information acquired in step S22 (step S23).

Then, the learner 16 determines whether the error acquired when the second model 42 learned in step S23 is applied to the setting data is within the predetermined first range (step S24). The learner 16 may obtain this error by applying the second model 42 to the newly input setting data or by cross-validation of the data accumulated through repeated execution of steps S2 to S4 and S22.

When determination is made that the error is not within the first range (No in step S24), the process returns to step S2, and addition of data through re-execution of steps S2 to S4, S22, and S6 and learning of the second model 42 in step S23 are executed again. Additionally, in a case where the predetermined processing iterations in the learning of the second model 42 in step S23 are cut short, when determination in Step S24 is negative (No in step S24), learning iterations may continue by returning to step S23 without additional data collection. When determination is made that the error is within the first range in step S24 (Yes in step S24), the learner 16 learns the second model 42 based on the variable environment indicated by the environment information acquired in step S22 (step S25).

Then, the learner 16 determines whether the error acquired when the second model 42 learned in step S25 is applied to the setting data is within the predetermined second range (step S26). The second range is defined as a broader range than the first range. Since there is no variation in the fixed environment, the first range is defined as a relatively narrow range to obtain the second model 42 that fits better to the fixed environment in steps S23 to S24. By contrast, the second range is defined as a relatively broad range, considering the variability of the variable environment.

When determination is made that the error is not within the second range (No in step S26), the process returns to step S2, and addition of data through re-execution of steps S2 to S4, S22, and S6 and learning of the second model 42 in steps S23 and S25 are executed again. Additionally, in a case where the predetermined processing iterations in the learning of the second model 42 in step S25 are cut short, when determination in step S26 is negative (No in step S26), learning iterations may continue by returning to step S25 without additional data collection.

When determination is made that the error is within the second range in step S26 (Yes in step S26), the learner 16 determines whether the error has shrunk (step S27). Specifically, the learner 16 determines whether the magnitude of the error determined to be within the second range in step S26 has shrunk from the magnitude of the error determined to be within the first range in step S24.

When determination is made that the error has not shrunk (No in step S27), the process returns to step S2, and addition of data through re-execution of steps S2 to S4, S22, and S6 and learning of the second model 42 in steps S23 and S25 are executed again. Additionally, in a case where the predetermined processing iterations in the learning of the second model 42 in steps S23 and S25 are cut short, when determination in step S27 is negative (No in step S27), learning iterations may continue by returning to step S23 without additional data collection. When determination is made that the error has shrunk in step S27 (Yes in step S27), the model application process is completed.

As described above, the learner 16 first learns based on the fixed environment and then executes learning based on the variable environment. Therefore, the factors that may affect the capability of the processing device 10 are further separated, and the learning of the model to absorb the capability difference due to some of these factors is sequentially executed. This further reduces the computational load for learning the model.

### Embodiment 3

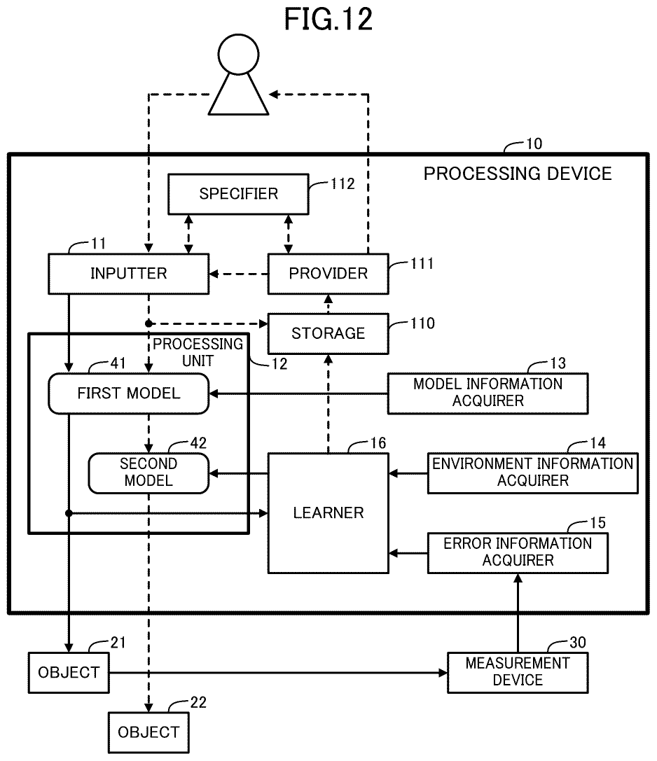

Next, Embodiment 3 is described, focusing on the differences from Embodiment 1 described above. The same reference signs denote the components that are the same as or similar to those in Embodiment 1. The present embodiment differs from Embodiment 1 in that the information used in the learning is stored and used when processing new objects, as illustrated in FIG. 12.

A processing device 10 according to the present embodiment includes a storage 110 that stores information used by the learner 16, a provider 111 that provides the information of the storage 110, and a specifier 112 that specifies specific data that corresponds to the setting data to be newly input based on the information of the storage 110.

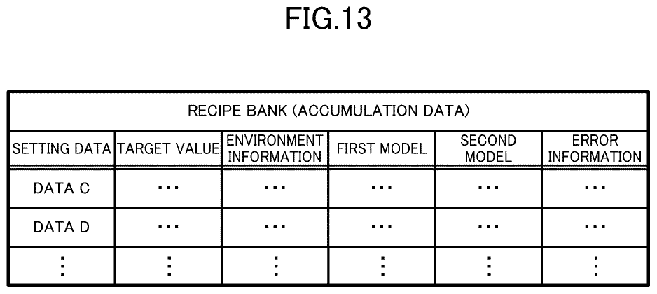

The storage 110 is mainly implemented by the auxiliary storage 103. The storage 110 repeatedly acquires the setting data input to the inputter 11 and stores the setting data associated with the information used by the learner 16. Specifically, the storage 110 stores a recipe bank as illustrated in FIG. 13.

The recipe bank is a database of accumulated records in which the setting data, the target value at the time the setting data is input, the environment information indicating the environment when the objects 21 and 22 are processed based on the setting data, the first and second models applied to the setting data, and the error information are associated with each other. The target value of the recipe bank may be included as part of the error information or may be input to the inputter 11 as part of the setting data or different from the setting data. The storage 110 corresponds to an example of accumulation means that accumulates, as accumulation data, a plurality of pieces of setting data each associated with the target value and a third error between the target value and the third processing result of the processing device that applies the first model and the second model to the setting data and processes the object.

The provider 111 is implemented by at least one of the processor 101 or the outputter 105. The provider 111 may read out the recipe bank from the storage 110 in response to the user's request and provide the recipe bank to the user. The user may specify, by referring to the provided recipe bank, the setting data that is associated with the target value desired by the user. Further, when the setting data associated with the target value desired by the user is associated with the error information indicating a relatively large error, the user may slightly change the setting data and then input the setting data to the inputter 11. Furthermore, when there is no record including the desired target value of the user in the recipe bank, the user may estimate suitable setting data by referring to multiple records. The provider 111 may also provide the recipe bank information to the specifier 112.

The specifier 112 is mainly implemented by a processor 101. When a target value is specified by the user through the inputter 11, the specifier 112 specifies, based on the recipe bank, the specific data corresponding to the setting data associated with the specified target value. Specifically, the specifier 112 may specify, as the specific data, the setting data associated with the target value specified by the user in the recipe bank. Additionally, when the setting data associated in the recipe bank with the target value specified by the user is also associated with error information indicating a relatively large error in the recipe bank, or when the recipe bank does not include a record including the target value specified by the user, the specifier 112 may specify the specific data corresponding to the setting data to be input for the target value by an estimation method such as linear interpolation of multiple records. The specifier 112 corresponds to an example of specifying means that specifies specific data corresponding to the setting data associated with a designated designation target value, based on the plurality of pieces of setting data and the third processing result of the processing device that applies the first model and the second model to each of the plurality of setting data and processes the object.

As described above, the recipe bank facilitates the determination of new setting data. The inputter 11 corresponds to an example of input means that receives the input of a new target value when processing new objects, and the specifier 112 corresponds to an example of specifying means that specifies the specific data corresponding to the setting data associated with the new target value. The processing device processes new objects based on the result of applying the first and second models to the specific data specified in accordance with the new target value.

### Embodiment 4

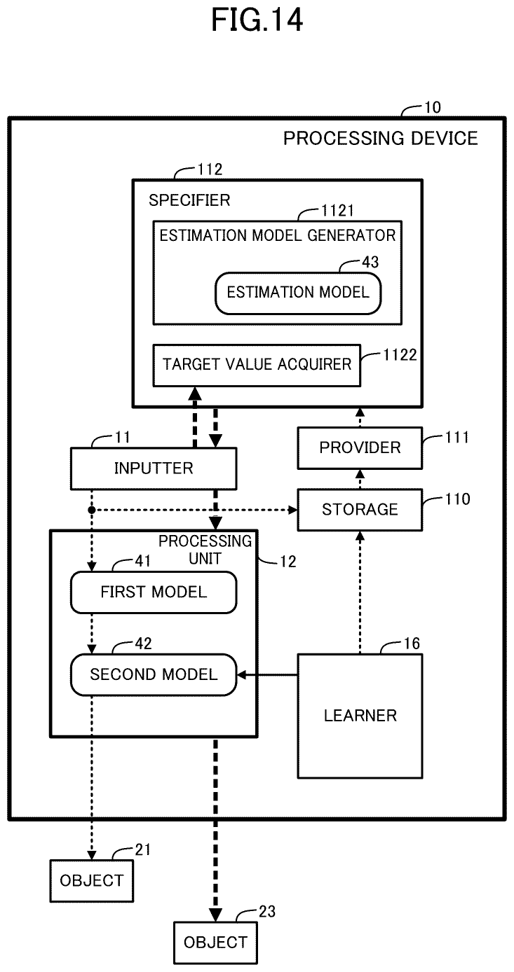

Next, Embodiment 4 is described, focusing on the differences from Embodiment 3 described above. The same reference signs denote the components that are the same as or similar to those in Embodiment 3. As illustrated in FIG. 14, the present embodiment differs from Embodiment 3 in that the specifier 112 generates an estimation model for estimating the setting data.

The specifier 112 according to the present embodiment includes an estimation model generator 1121 that generates an estimation model 43 for estimating appropriate setting data from the target value, and a target value acquirer 1122 that acquires a target value input to the inputter 11. In FIG. 14, the flow of information when using the estimation model is indicated by thick dashed lines.

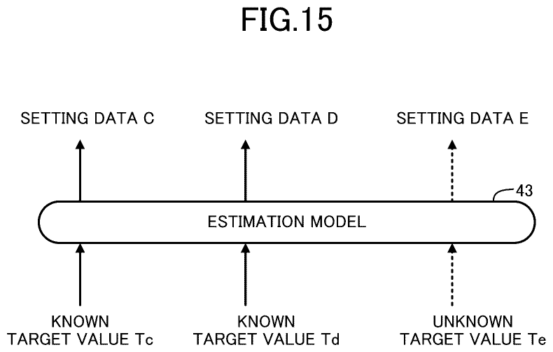

The estimation model generator 1121 reads out the recipe bank as illustrated in FIG. 13, and generates the estimation model 43 based on this recipe bank. Here, as illustrated in FIG. 15, the estimation model 43 is a model that specifies, as the specific data, the setting data to achieve the target value with a small error from the known target values included in the recipe bank and specifies the specific data to achieve the target value with a small error for unknown target values as well. Here, the small error means an error smaller than a predetermined threshold.

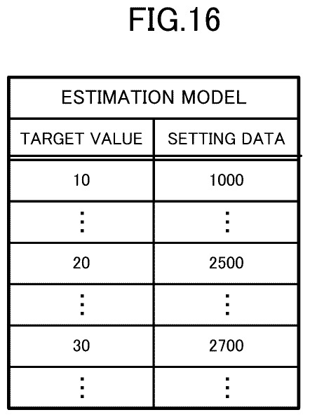

For example, even when the machining duration in cutting processing is doubled, the cutting amount does not necessarily double because the cutting amount depends on the blade shape. When the relationship between the setting data and the target value is not obvious to the user in this way, the estimation model is used. FIG. 16 illustrates a simple example of the estimation model. The estimation model generator 1121 generates the estimation model for obtaining, as specific data, the setting data that minimizes the error with respect to the target value, for example, by regression analysis or supervised learning, using the setting data as a response variable and the target value, the environment information, the first model 41, the second model, and the error information as explanatory variables.

The specifier 112 applies the estimation model 43 to the target value acquired by the target value acquirer 1122, and thereby specifies the specific data as the setting data to achieve the target value and inputs the specific data to the inputter 11. If the user inputs the target value without being conscious of selecting the setting data, the processing of the objects 23 to achieve the target value is executed.

The estimation model corresponds to an example of a model that estimates the specific data corresponding to the setting data associated with the designation target value. The specific data is for suppressing the third error between the target value and the third processing result of the processing device that applies the first and second models and processes the objects. The specifier 112 corresponds to an example of specifying means that generates the estimation model based on the accumulated data and applies the estimation model to the new target value, and thereby specifies the specific data corresponding to the setting data associated with the new target value.

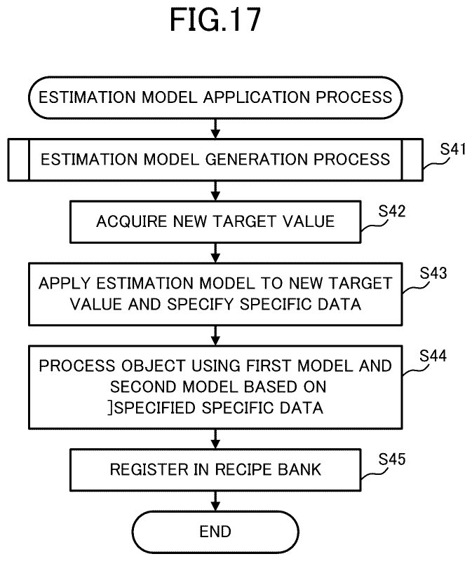

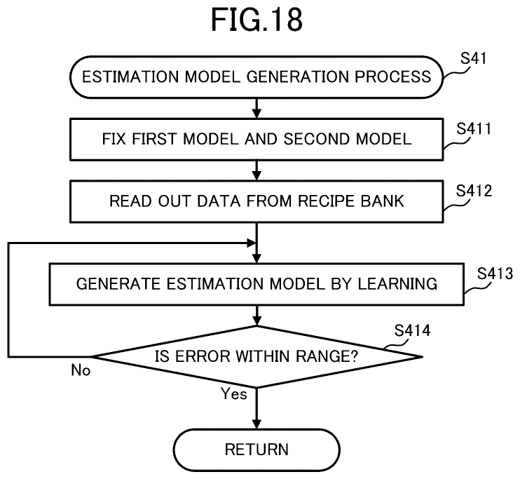

Next, the estimation model application process executed by the processing device 10 is described with reference to FIGS. 17 and 18. This estimation model application process is executed after the model application process illustrated in FIG. 6. That is, the estimation model application process is executed after learning of the second model 42.

In the estimation model application process illustrated in FIG. 17, the specifier 112 executes the estimation model generation process (step S41). In the estimation model generation processing, as illustrated in FIG. 18, the specifier 112 fixes the first model 41 and the second model 42 (step S411) and reads out data from the recipe bank of the storage 110 (step S412). Here, the fixation of the first model 41 and the second model 42 in step S411 means that neither the first model 41 nor the second model 42 is newly learned. Therefore, in a case where a different first model 41 or second model 42 is registered in accordance with the conditions such as setting data or environmental information in the recipe bank, records indicating different first model 41 and second model 42 may be read out in step S412.

Next, the estimation model generator 1121 generates the estimation model 43 by learning from the data read out in step S412 (step S413). Then, the estimation model generator 1121 determines whether the error when applying the estimation model 43 generated in step S413 to the new target value is within a predetermined range (step S414). The estimation model generator 1121 may obtain the error in step S414 using the target value newly input by the user or obtain the error in step S414 by cross-validation of the data read out in step S412.

When determination is made that the error is not within the range (No in step S414), the estimation model generator 1121 repeats the processing from step S413 onward and continues to learn the estimation model. Specifically, in the learning of the estimation model 43 in the previous step S413, the estimation model generator 1121 starts the iteration of the processing from the point where the predetermined processing iteration is terminated. In a case where not all data has been read out from the recipe bank in step S412, when the determination of step S414 is negative (No in step S414), the specifier 112 may return to step S412 to read out new data. When determination is made in step S414 that the error is within the range (Yes in step S414), the processing by the processing device 10 returns from the estimation model generation process to the estimation model application process in FIG. 17.

Returning to FIG. 17, following the estimation model generation process of step S41, the target value acquirer 1122 acquires the target value newly input to the inputter 11 (step S42), and the specifier 112 specifies the specific data by applying the estimation model 43 to the new target value (step S43).

Next, the processing unit 12 processes the objects 23 using the first model 41 and the second model 42 based on the specified specific data (step S44). Then, a record of processing the objects 23 is registered in the recipe bank of the storage 110 (step S45). The record registration may be performed by the learner 16 or the processing unit 12.

As described above, according to the specifier 112, the user can execute the processing of the objects 23 based on the appropriate specific data by merely inputting the target value. Additionally, by adding and enriching the information in the recipe bank of the storage 110, the specifier 112 is expected to specify more appropriate specific data.

### Embodiment 5

Next, Embodiment 5 is described, focusing on the differences from Embodiment 4 described above. The same reference signs denote the components that are the same as or similar to those in Embodiment 4. In the present embodiment, the learning of the second model 42 and the learning of the estimation model 43 are alternately repeated.

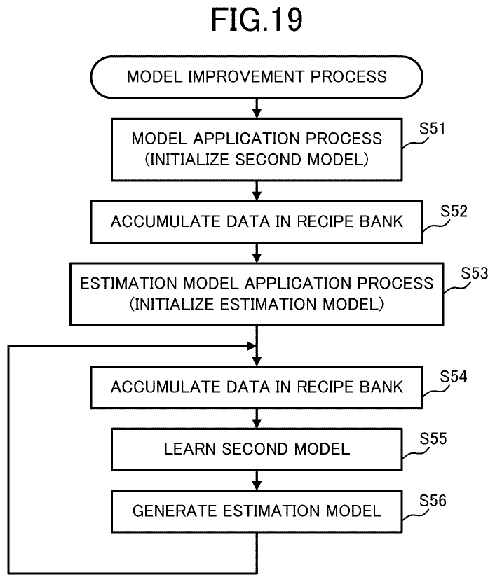

FIG. 19 illustrates the flow of the model improvement process executed by the processing device 10 according to the present embodiment. In the model improvement process, the model application process as illustrated in FIG. 6 is executed (step S51). This initializes the second model 42.

Next, data is accumulated in the recipe bank (step S52). Specifically, the processing of the object 22 using the second model 42 based on the newly input setting data is executed multiple times, and information of processing the object 22 is accumulated in the storage 110.

Next, the estimation model application process as illustrated in FIG. 17 is executed (step S53). This initializes the estimation model 43.

Next, data is accumulated in the recipe bank (step S54). Specifically, the processing of an object 23 is executed multiple times in which specific data is specified by applying the estimation model 43 to the newly input target value and the second model 42 is used based on the specified specific data. Then, information of processing the object 23 is accumulated in the storage 110.

Next, the learner 16 learns the second model 42 based on the data accumulated in step S54 (step S55). This improves the second model 42. Then, the estimation model generator 1121 generates the estimation model 43 (step S56). This improves the estimation model 43. Then, the processing device 10 repeats the processing from step S54 onward.

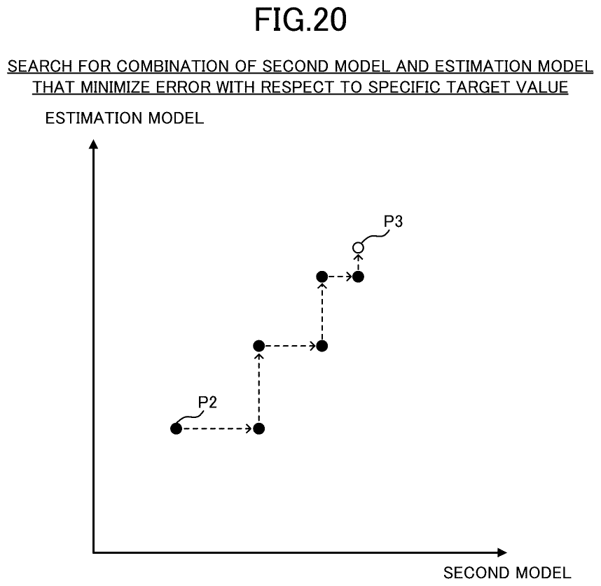

Thus, as illustrated schematically in FIG. 20, a search for a combination of the second model 42 and the estimation model 43 that minimizes the error with respect to a specific target value is performed. In FIG. 20, point P2 indicates the combination of initial values of the second model 42 and the estimation model 43. This point P2 moves as indicated by an arrow along the horizontal axis with the improvement of the second model 42 and further moves as indicated by an arrow along the vertical axis with the improvement of the estimation model 43. By repeating such movements, the second model 42 and the estimation model 43 are expected to approach point P3 corresponding to the combination that minimizes the error.

Although embodiments of the present disclosure have been described above, the present disclosure is not limited to the above embodiments.

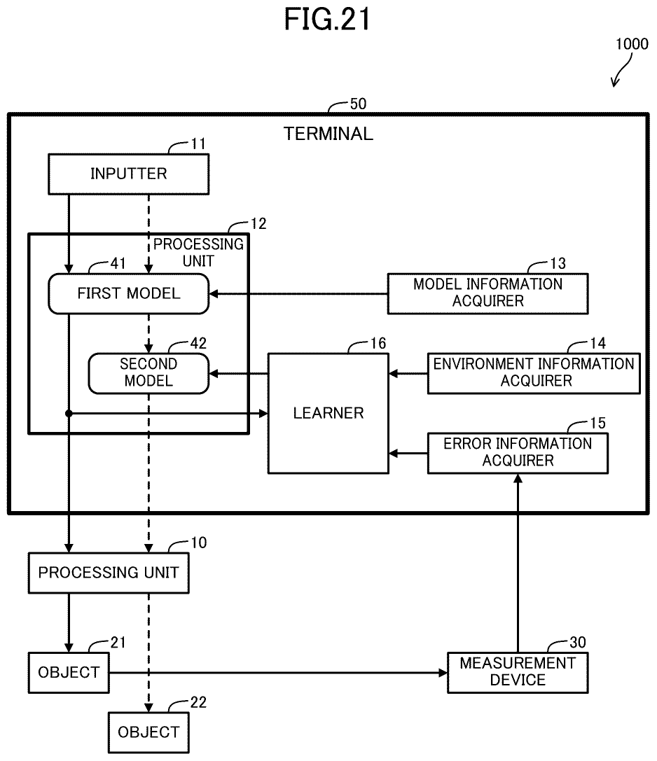

For example, although the processing system 1000 is equal to the processing device 10 in the example described above, the example is not limited thereto. For example, as illustrated in FIG. 21, the processing system 1000 may include a terminal 50, which includes an inputter 11, a processing unit 12, a model information acquirer 13, an environment information acquirer 14, an error information acquirer 15, and a learner 16, and the processing device 10, which is a machine tool. Here, the terminal 50 is a user interface (UI) terminal for operating the processing device 10, for example, an industrial personal computer (PC). Even in the example illustrated in FIG. 21, the processing device 10 processes the object based on the results of applying the first model 41 and the second model 42 to the setting data.

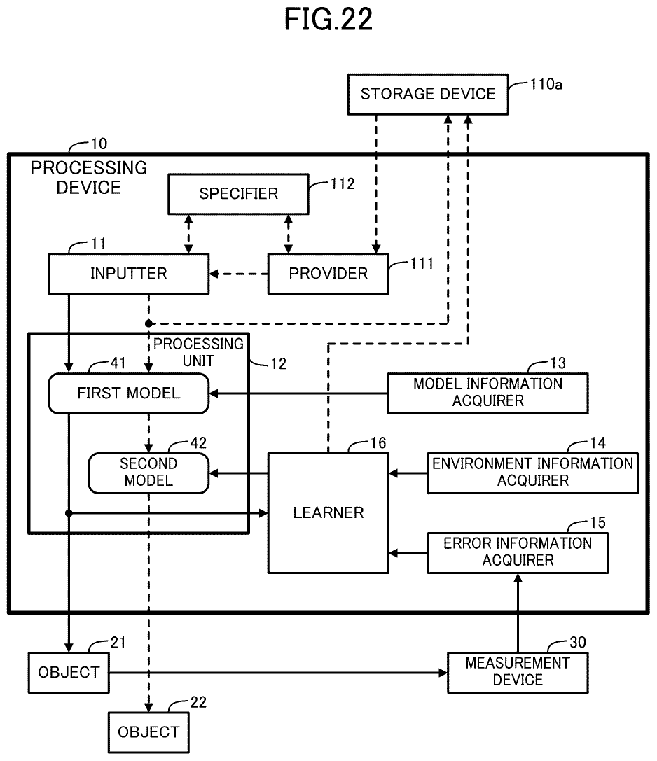

Also, as illustrated in FIG. 22, the recipe bank may be stored in an external storage device 110a instead of the storage 110 of the processing device 10.

The above-described embodiments may be combined arbitrarily. For example, the characteristic information acquirer 18 and the model generator 19 according to Embodiment 2 and the storage 110, the provider 111, and the specifier 112 according to Embodiments 3 and 4 may be included in the terminal 50 illustrated in FIG. 21.

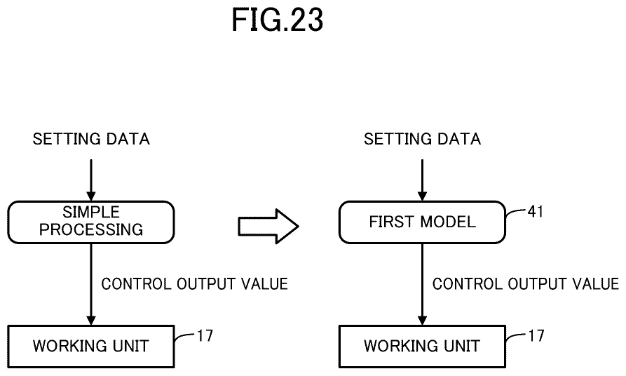

Although the first model 41 and the second model 42 are used to obtain the correction value of the setting data from the setting data in the example described above, but the example is not limited thereto. For example, as illustrated in FIG. 23, in a case where simple processing is pre-defined to output, based on the setting data, a control output value that is different from the setting data and provided to the working unit 17 that processes the objects, the first model 41 may output, based on the setting data, a more appropriate control output value than that in the simple processing. Here, the setting data is, for example, a movement speed of the tool in cutting processing, and the control output value is a value of current flowing into the motor for a spindle for rotating the tool and the motor for a movement axis for moving the stage. The second model 42 may obtain the output value of the first model 42 and output the correction value of the output value, or may obtain the setting data and output the correction value of the output of the first model 41. In the example of FIG. 23, the model generator 19 that generates the first model 41 may use learning data including the history of the control output value.

Also, the learner 16 that learns the second model 42 may use learning data including the history of the control output value.

It is sufficient that the first model 41 and the second model 42 have inputs and outputs included in the flow starting from the setting data input by the user and ending with processing the objects based on the setting data. It is sufficient that the processing device 10 processes the object based on the results of applying the first model 41 and the second model 42 to the setting data.

The function of the processing system 1000 according to the above-described embodiments may be achieved by dedicated hardware or a general computer system.

For example, the program P1 may be stored into a non-transitory computer-readable recording medium, such as a flexible disk, a compact disk read-only memory (CD-ROM), a digital versatile disk (DVD), and a magneto-optical disk (MO), for distribution and then installed in a computer to configure a device for performing the above-described processes.

The program P1 may be stored in a disk device included in a server on a communication network, such as the Internet, and may be, for example, superimposed on a carrier wave to be downloaded to a computer.

The above-mentioned processing can also be achieved by starting and executing the program P1 while transferring the program P1 over a network represented by the Internet.

A server device may execute all or part of the program P1 and a computer may execute the program P1 while transmitting and receiving information on the executed processes to and from the server device via a communication network, to perform the above-described processes.

In the system with the above functions implementable partially by an operating system (OS) or through cooperation between the OS and applications, portions executable by applications other than the OS may be stored in a non-transitory recording medium that may be distributed or may be downloaded to a computer.

Means for implementing the functions of the processing system 1000 is not limited to software, and may be partially or entirely implemented by dedicated hardware or a dedicated circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

Industrial Applicability The present disclosure is suitable for reducing performance variations of devices installed at FA sites.

### Reference Signs List

10, 10a, 10b Processing device
11 Inputter
12 Processing unit
13 Model information acquirer
14 Environment information acquirer
15 Error information acquirer
16 Learner
17 Working unit
18 Characteristic information acquirer
19 Model generator
20-23 object
30 Measurement device
41 First model
42 Second model
43 Estimation model
50 Terminal
100 Factory
100a Production site
101 Processor
102 Main storage
103 Auxiliary storage
104 Inputter
105 Outputter
106 Communicator
107 Internal bus
110 Storage
110a Storage device
111 Provider
112 Specifier
1000 Processing system
1121 Estimation model generator
1122 Target value acquirer
P1 Program
P2, P3 Point

1. A processing system, comprising:
a processing device to be installed in a factory and process an object based on setting data; and
processing circuitry to
receive input of the setting data,
acquire model information indicating a first model to be applied to the setting data to suppress a first error included in a first processing result of the processing device due to a unique characteristic that is unique to the processing device before being installed in the factory,
acquire factory environment information indicating environment of the processing device installed in the factory.
acquire first error information indicating a second error between a target value and a second processing result of the processing device that processes the object in the factory using the first model based on the setting data input in the factory, and
learn a second model to suppress the second error from the factory environment information and the first error information, wherein
the processing device processes the object based on results of applying the first model and the second model to the setting data.

2. The processing system according to claim 1, wherein information for use by the processing circuitry to learn the second model excludes information indicating the unique characteristic.

3. The processing system according to claim 1, wherein
the processing circuitry
specifies, based on a plurality of pieces of the setting data and a third processing result of the processing device that processes the object by applying the first model and the second model to each of the plurality of pieces of setting data, specific data that corresponds to setting data associated with a designated designation target value,
receives input of a new target value for processing of a new object, and
specifies the specific data that corresponds to the setting data associated with the new target value, and
the processing device processes the new object based on results of applying the first model and the second model to the specific data specified in accordance with the new target value.

4. The processing system according to claim 3, wherein
the processing circuitry
accumulates, as accumulation data, the plurality of pieces of setting data each associated with the target value and the third error between the target value and the third processing result, and
specifies the specific data that corresponds to the setting data associated with the new target value by generating, based on the accumulation data, an estimation model that estimates the specific data corresponding to the setting data associated with the designation target value and suppressing the third error, and by applying the estimation model to the new target value.

5. The processing system according to claim 4, wherein the learning of the second model by the processing circuitry and the generation of the estimation model by the processing circuitry are alternately repeated.

6. The processing system according to claim 1, wherein the first model is a model for obtaining, from the setting data, a corrected value of the setting data.

7. The processing system according to 1, wherein the second model is a model for obtaining, from the output value of the first model and the factory environment information, a corrected value of the output value.

8. The processing system according to claim 1, wherein
the processing circuitry
acquires characteristic information indicating the unique characteristic,
generates the first model, acquires production environment information indicating the environment at the production site where the processing device is produced,
acquires second error information indicating the first error, and
generates the first model from the characteristic information, the production environment information, and the second error information.

9. A processing method, comprising:
receiving, by an inputter, input of setting data;
acquiring, by a model information acquirer, model information indicating a first model to be applied to the setting data to suppress a first error included in a first processing result of a processing device due to a unique characteristic before being installed at a factory, the processing device being installed in the factory and processing an object based on the setting data;
acquiring, by an environment information acquirer, environment information indicating environment of the processing device installed in the factory;
acquiring, by an error information acquirer, error information indicating a second error between the target value and a second processing result of the processing device that processes the object in the factory using the first model based on the setting data input in the factory;
learning, by a learner, a second model for suppressing the second error from the environment information and the error information; and
processing, by the processing device, the object based on the results of applying the first model and the second model to the setting data.

10. A non-transitory computer-readable recording medium storing a program for causing a computer to execute processing, the processing comprising:
receiving setting data;
acquiring model information indicating a first model to be applied to the setting data to suppress a first error included in a first processing result of a processing device due to a unique characteristic before being installed at a factory, the processing device being installed in the factory and processing an object based on the setting data;
acquiring environment information indicating environment of the processing device installed in the factory;
acquiring error information indicating a second error between the target value and a second processing result of the processing device that processes the object in the factory using the first model based on the setting data input in the factory;
learning a second model for suppressing the second error from the environment information and the error information; and
processing the object based on the results of applying the first model and the second model to the setting data.
